(19) United States
(12) Patent Application Publication
(10) Pub. No.: US 2007/0025204 A1
(43) Pub. Date: Feb. 1, 2007

(54) Objective optical system for optical recording media and optical pickup device using it

(75) Inventors: Masao Mori, Saitama City (JP); Toshiaki Katsuma, Tokyo (JP); Tetsuya Ori, Koshigaya City (JP); Yu Kitahara, Saitama City (JP)

Correspondence Address: ARNOLD INTERNATIONAL, P. O. BOX 129, GREAT FALLS, VA, 22066-0129, US

(73) Assignee: FUJINON CORPORATION

(21) Appl. No.: 11/492,085

(22) Filed: Jul. 25, 2006

(30) Foreign Application Priority Data
Jul. 29, 2005 (JP) 2005-222151

(51) Int. Cl. G11B 7/00; G11B 7/135

(52) U.S. Cl. 369/44.23; 369/112.1

(57) ABSTRACT

An objective optical system for optical recording media and an optical pickup device using the objective optical system includes a holographic optical element that includes angularly-multiplexed holograms for correcting spherical aberration and/or coma aberration due to variations in substrate thicknesses of recording media and errors by tilting the holographic optical element out of the plane perpendicular to the optical axis by specified amounts. A control system determines the spherical aberration and/or coma using a control unit and outputs command signals for controlling the amount of tilt. The angularly-multiplexed holograms may change an input substantially collimated light beam to a divergent or convergent light beam except when the substrate of the optical recording media has a specified thickness. Additionally, the holographic optical element may include wavelength-multiplexed holograms to correct for chromatic aberration due to mode hopping of a semiconductor laser light source.

### FIELD OF THE INVENTION

The present invention relates to an objective optical system for optical recording media and an optical pickup device using the objective optical system that, when recording or reproducing information, efficiently focuses light of different wavelengths onto an appropriate corresponding recording medium. More specifically, the present invention relates to an objective optical system for optical recording media and an optical pickup device using the objective optical system in which the value of its numerical aperture (NA) when used with optical recording media having a high density of recorded information is higher than about 0.65.

### BACKGROUND OF THE INVENTION

In response to the development of various optical recording media in recent years, optical pickup devices that can record information on and reproduce information from various types of optical recording media have been known. For example, individual devices or combinations of devices that record or reproduce information with either a DVD (Digital Versatile Disk) or a CD (Compact Disk including CD-ROM, CD-R, CD-RW) have been practically used.

In addition, a semiconductor laser with a short wavelength, for example, a laser that emits a laser beam with a wavelength of 408 nm using a GaN substrate, has been put into practical use. Also, in response to demand for increased recording capacity, AODs (Advanced Optical. Disks or HD-DVDs) that provide approximately 20 GB of data storage on a single layer of a single side of an optical disk by using short wavelength light as irradiation light are about to be put into practical use. Furthermore, Blu-ray Discs (BDs) where light with a short wavelength is used as an irradiation light similar to the AODs are almost ready to be put into practical use.

According to the standards for AODs, the numerical aperture and the substrate thickness are standardized to similar values as those of DVDs, specifically a numerical aperture (NA) of 0.65 and a substrate thickness of 0.6 mm. In contrast, in the standards for BDs, the numerical aperture and the substrate thickness are standardized to completely different values from the values for DVDs and CDs. Specifically, for BDs, the standard numerical aperture (NA) is 0.85 and the standard substrate thickness is 0.1 mm.

More specifically, in optical recording media using a short wavelength for recording as described above, in order to further increase the recording density, the designs make smaller the light spots illuminating the recording surface of the optical recording media by using a numerical aperture (NA) of 0.65 or, in the case of a BD, a numerical aperture (NA) of 0.85 (which is quite large).

However, as the numerical aperture (NA) of the objective optical system becomes larger, various aberrations, including spherical aberration, coma aberration, and chromatic aberration, also become larger due to various errors, making it necessary to take new measures to appropriately correct the aberrations.

Measures for correcting various aberrations such as chromatic aberration and wavefront aberrations that include spherical aberration and coma aberration are known and disclosed, for example, in Japanese Laid-Open Patent Applications 2002-150598, 2001-296472, and 2004-334031.

However, with the conventional approaches described in the references cited above, it will be difficult to meet the standards for correcting aberrations to the degree expected to be required in the future. Therefore, there is an urgent need to develop fundamentally new technologies for correcting aberrations.

There is especially a demand for technologies for effectively and accurately correcting spherical aberration that is associated with differences in the substrate thicknesses of individual optical recording media, coma aberration associated with image surface blurring caused by slight differences in the tilts of the disks of optical recording media in their recording and reproducing positions, and chromatic aberration associated with mode hopping of the light wavelength of the semiconductor laser light source. Furthermore, there is also a demand for technology for effectively and accurately correcting spherical aberration created among multi-layered recording domains in multi-layered discs that are expected to be developed in the future.

### BRIEF SUMMARY OF THE INVENTION

The present invention relates to an objective optical system for optical recording media and an optical pickup device using the objective optical system that effectively and accurately corrects for various aberrations associated with various errors.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 is a schematic diagram of an optical pickup device that uses an objective optical system for optical recording media according to a first embodiment of the invention;

FIGS. 2A-2C are schematic diagrams that depict cross-sectional views of the objective optical system for optical recording media of FIG. 1, with FIG. 2A showing the operation of the objective optical system wherein a substantially collimated light beam exits the hologram when using a first optical recording medium 9 of standard thickness, in which case the holographic optical element is positioned with its surface normal parallel to the optical axis of the objective optical system, with FIG. 2B showing the operation of the objective optical system wherein a divergent light beam exits the holographic optical element when using a second optical recording medium 9 that is thicker than the standard thickness, in which case the holographic optical element is tilted as illustrated, and with FIG. 2C showing the operation of the objective optical system wherein a converging light beam exits the holographic optical element when using a third optical recording medium 9 that is thinner than the standard thickness, in which case the holographic optical element is tilted in the opposite direction of that shown in FIG. 2B;

FIGS. 3A-3B are diagrams that show one and two axes of rotation, respectively, of the holographic optical element of the objective optical system for optical recording media of FIG. 1;

FIG. 4 is a schematic diagram for explaining the formation of angularly-multiplexed holograms in the holographic optical element of the objective optical system for optical recording media of FIG. 1 by tilting the holographic optical element;

FIG. 5 is a schematic diagram of an optical pickup device that uses the objective optical system for optical recording media according to a second embodiment of the invention; and

FIG. 6 is a schematic diagram for explaining the formation of multiple holograms in the holographic optical element of the objective optical system for optical recording media of FIG. 5 by wavelength variations of the light used for recording the holograms.

### DETAILED DESCRIPTION

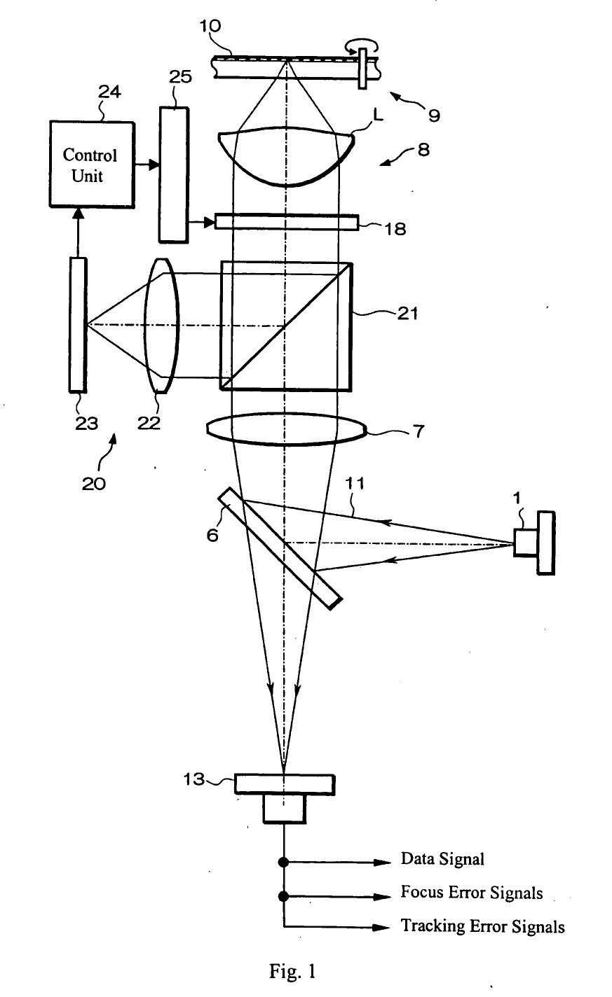

An embodiment of the present invention will be described below with reference to the drawings. FIG. 1 is a schematic diagram of an optical pickup device that uses the objective optical system for optical recording media according to a first embodiment of the invention.

In the optical pickup device shown in FIG. 1, laser light 11 emitted from a semiconductor laser 1 is reflected by a half-mirror 6 and then is collimated or nearly collimated by a collimator lens 7 and converged by an objective optical system 8 so as to focus the laser light onto a recording domain 10 of an optical recording medium 9.

Here, the optical recording medium 9 is assumed to be a BD (wherein the numerical aperture NA is 0.85, the wavelength of light used is 408 nm, and the substrate thickness d is 0.1 mm). However, other optical recording media such as an AOD (wherein, the numerical aperture NA is 0.65, the wavelength of light used is 408 nm, and the substrate thickness d is 0.6 mm), a DVD (wherein the numerical aperture NA is 0.65, the wavelength of light used is 658 nm, and the substrate thickness d is 0.6 mm), or a CD (wherein the numerical aperture NA is 0.50, the wavelength of light used is 784 nm, and the substrate thickness d is 1.2 mm) may instead be used. Furthermore, an optical pickup device that can be used with any selected one of the above-mentioned plurality of optical recording media 9 may be used.

The semiconductor laser 1 is a light source capable of emitting light of a wavelength used with the optical recording media 9. The laser light 11 emitted from the semiconductor laser 1 is designed to be reflected by the half-mirror 6.

In addition, the collimator lens 7 is schematically shown in FIG. 1 and may include a configuration that employs more than a single lens element. Indeed, it is preferable that a configuration of the collimator lens be adopted that corrects for chromatic aberration.

The optical pickup device of FIG. 1 is configured with an infinite conjugate on the light source side of the objective optical system 8 so that a substantially collimated light beam is incident on the objective optical system 8. In addition, the objective optical system 8 includes a holographic optical element 18 positioned on the light source side of an objective lens L such that the holographic optical element 18 can be tilted relative to the optical axis.

Also, the optical pickup device of FIG. 1 includes a control system 20 to reduce the aberrations that are generated. The control system 20 includes a beamsplitter 21 for reflecting at a right angle part of the light returned from the optical recording medium 9, a condenser lens 22 for collecting the reflected light, a light detector 23 for detecting the light collected by the condenser lens, a control unit 24 for determining the extent of spherical aberration and/or coma aberration based on the light intensity received by the light detector 23 and for outputting command signals to tilt the holographic optical element 18 by a selected angle in order to reduce the aberration(s) based on the detection results, and an actuator 25 to drive the holographic optical element 18 so as to be tilted according to the command signals.

In addition, pits carrying signal information are arranged within a recording domain 10 in a track and the reflected light of the laser light 11 from the recording domain 10 enters the half-mirror 6 via the objective optical system 8 and the collimator lens 7. Light reflected from the recording medium carries signal information and enters a four-part photodiode 13 after passing through the half-mirror 6. In the photodiode 13, the amount of light received at each of the four-part diode positions is converted to electrical signals, and a specific calculation is carried out by a calculator, not shown in the drawings, based on the amount of light received in order to obtain data signals and error signals for focusing and tracking.

Furthermore, because the half-mirror 6 is inserted at a forty-five degree tilt angle relative to the optical axis of the returned light from the optical recording medium 9, the half-mirror acts in a manner similar to a cylindrical lens in that the light beam transmitted by the half-mirror 6 has astigmatic aberration that may be used to determine the amount of focusing error according to the beam spot shape of the returned light on the four-part photodiode 13. In addition, it is also possible to insert a grating between the semiconductor laser 1 and the half-mirror 6 in order to detect tracking errors.

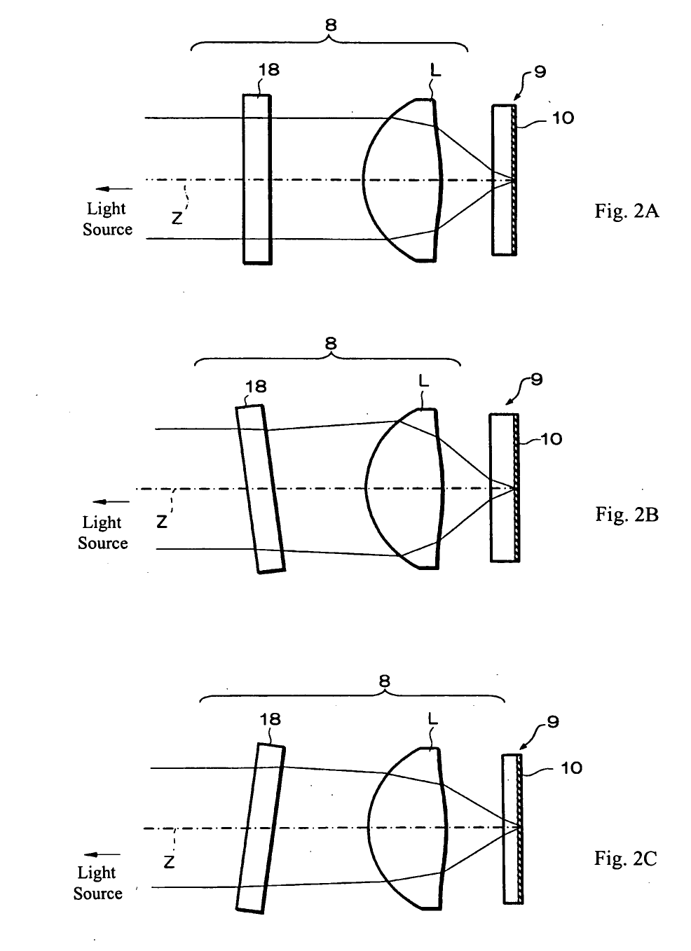

Next, the action of the objective optical system for optical recording media of FIG. 1 will be explained with reference to FIGS. 2A-2C. FIGS. 2A-2C are schematic diagrams that depict cross-sectional views of the objective optical system for optical recording media of FIG. 1. FIG. 2A shows the operation of the objective optical system wherein a substantially collimated light beam exits the holographic optical element when using a first optical recording medium 9 of standard thickness, in which case the holographic optical element is positioned with its surface normal parallel to the optical axis of the objective optical system. FIG. 2B shows the operation of the objective optical system wherein a divergent light beam exits the holographic optical element when using a second optical recording medium 9 that is thicker than the standard thickness, in which case the holographic optical element is tilted as illustrated. FIG. 2C shows the operation of the objective optical system wherein a converging light beam exits the holographic optical element when using a third optical recording medium 9 that is thinner than the standard thickness, in which case the holographic optical element is tilted in a direction opposite that shown in FIG. 2B.

In the objective optical system for optical recording media of FIG. 1, collimated or nearly collimated light is incident on the holographic optical element 18. Holographic optical element 18 includes angularly-multiplexed holograms and the objective optical system is designed so that the holographic optical element may be tilted to specified directions. As shown in FIG. 2B, the top of the holographic optical element 18 is tilted toward the light source side a specified amount, to be discussed later, when the optical recording medium 9 is thicker than the standard thickness and this tilting results in the beam being diffracted by the holographic optical element 18 and exiting the holographic optical element as a divergent light beam. Furthermore, as shown in FIG. 2C, the top of the holographic optical element 18 is tilted toward the optical recording medium side a specified amount when the optical recording medium 9 is thinner than the standard thickness and this tilting results in the beam being diffracted by the holographic optical element 18 and exiting the holographic optical element as a convergent light beam. In addition, when the substrate thickness of the optical recording medium 9 is a specific standard thickness, the holographic optical element 18 is designed to not affect the convergence/divergence of the light exiting the holographic optical element so that a substantially collimated light beam, as shown in FIG. 2A, is transmitted by the holographic optical element without being diffracted. In FIGS. 2A-2C, collimated light enters the objective optical system from the left parallel to the optical axis Z.

Angularly-multiplexed holograms are formed in the holographic optical element 18 and, when a specific hologram is needed for correction of aberrations, the holographic optical element 18 is tilted to the particular angle used in recording that specific hologram. In addition, the specific types of aberrations to be reduced in the optical pickup device of FIG. 1 are spherical aberration and coma aberration, and it is possible to design the optical pickup device so that these two kinds of aberration are simultaneously reduced.

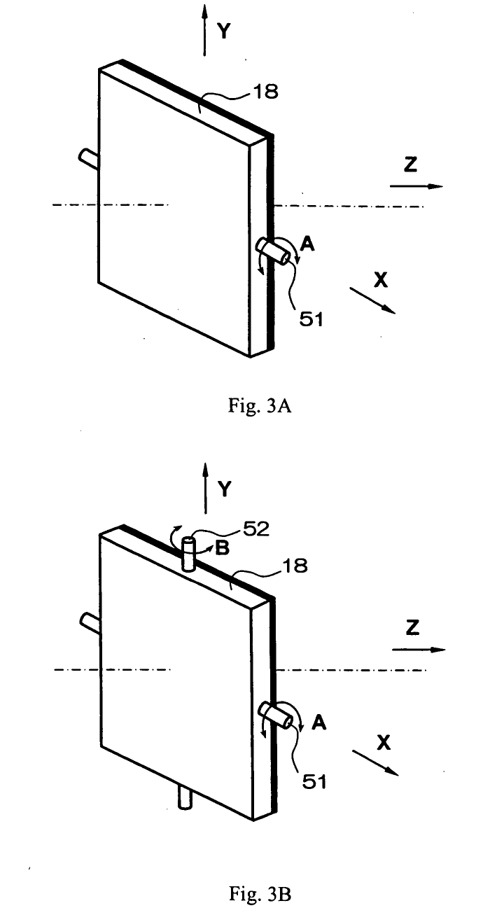

Furthermore, as shown in FIG. 3A, the holographic optical element 18 is designed to be driven by the actuator 25 to rotate in the direction of arrow A to a specific angle about the axis of rotation 51 that extends in the X axis direction. In this manner, the holographic optical element 18 is tilted to a specific angle relative to the Y axis. As a particular embodiment of the actuator 25, a voice coil, for example, may be used. By changing the current running through the voice coil, the holographic optical element 18 may be driven to rotate by a specified angle.

Additionally, to simultaneously reduce two kinds of aberrations in a manner as described above, for example as shown in FIG. 3B, the holographic optical element 18 is rotated in the direction of arrow A to a specific angle about the axis 51 that extends in the X axis direction, and is simultaneously rotated in the direction of arrow B to a specific angle about the axis 52 that extends in the Y axis direction. In this case, the holographic optical element 18 can be supported using a two-axis gimbal mechanism. With such a construction, the holographic optical element 18 may be tilted about the X axis and the Y axis independently to specific angles. In this case, by tilting the holographic optical element 18 about the X axis a specific angle, spherical aberration is corrected and by tilting the holographic optical element 18 about the Y axis a specific angle, coma aberration (that is associated with blurring of the light beam focus (e.g., at a recording surface)) is corrected. This assumes that collimated or nearly collimated light is incident on the holographic optical element 18.

The holographic optical element 18 includes angularly-multiplexed holograms with interference patterns that are recorded so that a specific amount of spherical aberration or coma aberration is corrected for a particular angle of recording. During the recording/reading operation with the optical recording medium 9, when the amounts of spherical aberration and coma are detected by the control unit 24, the holographic optical element 18 is set by the actuator 25 to have a tilt so that the appropriate corresponding angularly-multiplexed hologram for correcting the spherical aberration and coma is used in reading the data on the recording medium 9.

A method of manufacturing the holographic optical element 18 with the angularly-multiplexed hologram recordings, as described above, will now be described.

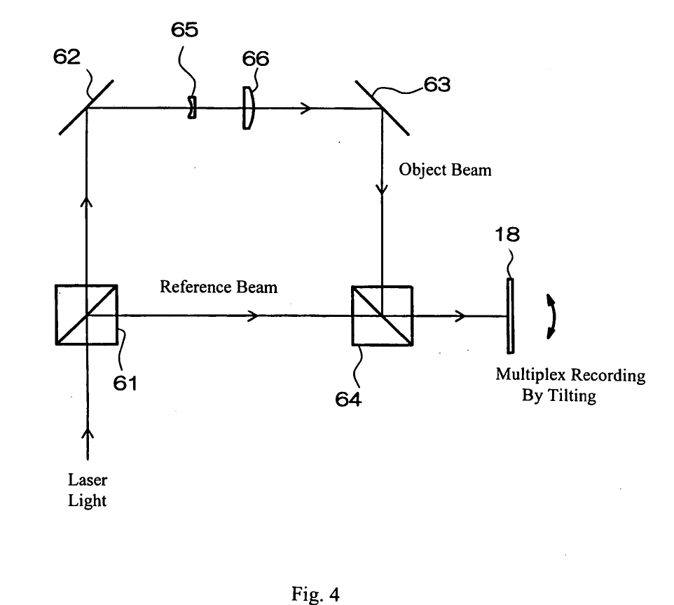

FIG. 4 is a schematic diagram for explaining the formation of angularly-multiplexed holograms in the holographic optical element of the objective optical system for optical recording media of FIG. 1 by tilting the holographic optical element. Multiple exposures may be used, for example, to form the angularly-multiplexed holograms, and these holograms may be used for correcting spherical aberration. Additionally, a voice coil may be used for tilting the holographic optical element 18 so as to play out an appropriate hologram by changing the current running through the voice coil.

In recording the angularly-multiplexed holograms, first, after a laser beam has had its beam diameter expanded and it has been substantially collimated by an optical system (not shown in the drawings), a beamsplitter 6.1 splits the substantially collimated light beam into an object beam and a reference beam. As shown in FIG. 4, the object beam enters a beamsplitter 64 via a beam expander made up of two mirrors 62, 63, a concave lens 65 and a convex lens 66, and the reference beam (that is split off by the beamsplitter 61 reflecting light at a right angle) also enters the beamsplitter 64. The distance between the concave lens 65 and the convex lens 66 is set to a standard distance so that collimated light exits the beam expander. In the beamsplitter 64, the object beam and the reference beam are combined so as to generate light interference. Subsequently, the holographic optical element 18, that is set perpendicular to the optical axis of the combined light beam, is illuminated by the combined light beams. Thus, a first interference pattern that defines a hologram is recorded on known light sensitive materials of the holographic optical element 18.

Furthermore, while maintaining the reference beam in the same state, the distance along the optical axis between the concave lens 65 and the convex lens 66 of the beam expander is changed by a specific distance, for example a few micrometers, in order to change the object beam so that the light exiting from the beam expander becomes diverging or converging light. Moreover, the holographic optical element 18 is tilted about the X axis or Y axis by a specified angle, such as 0.5 degrees, for example. After accomplishing these adjustments, a second interference pattern that defines a hologram is recorded on the holographic optical element 18. Thus, the holographic optical element 18 for correcting spherical aberration may be formed of angularly-multiplexed holograms that use different distances between the concave lens 65 and the convex lens 66 and different tilt angles of the holographic optical element 18, for example, tilt angles recorded at 0.5 degree increments. In this manner, different interference patterns are recorded on the holographic optical element 18.

In addition, the range of the tilt angles of the holographic optical element 18 during recording may be, for example, approximately ±2 degrees. In this case, the hologram is formed of nine angularly-multiplexed recordings of interference patterns, each at a different tilt angle of the holographic optical element 18. Moreover, the + and − signs for the tilt angle of the holographic optical element 18 are arbitrarily assigned. In other words, positive tilt may indicate that the holographic optical element 18 is tilted in the direction shown in FIG. 2B, and negative tilt may indicate that the holographic optical element 18 is tilted in the direction shown in FIG. 2C, or vice-versa.

For example, when the tilt angle is +2 degrees, the holographic optical element 18 records the interference pattern for correcting spherical aberration associated with a substrate thickness error of +20 micrometers, while, for example, when the tilt angle is −2 degrees, the holographic optical element 18 records the interference pattern for correcting spherical aberration associated with a substrate thickness error of −20 micrometers, by which, during the recording/reading operation with the optical recording medium 9, the spherical aberration associated with a substrate thickness error of +20 micrometers is corrected by setting the tilt angle of the holographic optical element 18 to be +2 degrees. On the other hand, the spherical aberration associated with a substrate thickness error of −20 micrometers is corrected by setting the tilt angle of the holographic optical element 18 to be −2 degrees.

As with the above holographic optical element 18 for correcting spherical aberration, the holographic optical element 18 may also be formed so as to correct coma aberration by multiple exposures that form angularly-multiplexed holograms. A voice coil, for example, may be used to tilt the holographic optical element 18 between exposures by changing the current running through the voice coil.

In this case, with reference again to FIG. 4, the first interference pattern is formed in a manner similar to the case of formation of the holographic optical element 18 for correcting spherical aberration. Next, while maintaining the reference beam in the same state, the concave lens 65 and the convex lens 66 that form the beam expander are tilted as a unit relative to the optical axis by a specific angle, such as 0.5 degrees, so as to generate coma aberration in the object beam. Moreover, the holographic optical element 18 is tilted by a specific angle, such as 0.5 degrees, and in a specific direction about the X axis or the Y axis. After these adjustments, a second interference pattern that defines a hologram is recorded on the holographic optical element 18. Thus, the holographic optical element 18 for correcting coma may be formed of angularly-multiplexed holograms that are defined by different interference patterns on the holographic optical element 18.

In addition, the range of the tilt angles of the recordings of the holographic optical element 18 may be approximately ±2 degrees. For example, when the tilt angle is +2 degrees, the holographic optical element 18 records the interference pattern for correcting coma aberration of +2 degrees of disk tilt angle, while, for example, when the tilt angle is −2 degrees, the holographic optical element 18 records the interference pattern for correcting coma aberration of −2 degrees of disk tilt angle. Thus, it is preferable to design the holographic optical element 18 so that the tilt of the holographic optical element 18 and the tilt of the substrate correspond to each other.

Therefore, during the recording/reading operation with the optical recording medium 9, the coma aberration associated with +2 degrees of the disc tilt angle is corrected by setting the tilt angle of the holographic optical element 18 to be +2 degrees, whereas the coma aberration associated with −2 degrees of the disc tilt angle is corrected by setting the tilt angle of the holographic optical element 18 to be −2 degrees.

Moreover, although the above embodiment is one in which spherical aberration and coma aberration are corrected by using angularly-multiplexed holograms in the holographic optical element 18, wavelength-multiplexed holograms may also be recorded in the holographic optical element used for correcting chromatic aberration, as will be described below.

During the recording/reading operation with the optical pickup device, when a semiconductor laser is used as a light source, chromatic aberration is generated by minute wavelength variations of the laser due to a phenomenon known in the art as ‘mode hopping’. In order to correct chromatic aberration due to mode hopping, in this embodiment of the present invention, the holographic optical element is formed using wavelength-multiplexed recordings (i.e., recordings made using light at the different wavelengths generated by the different modes).

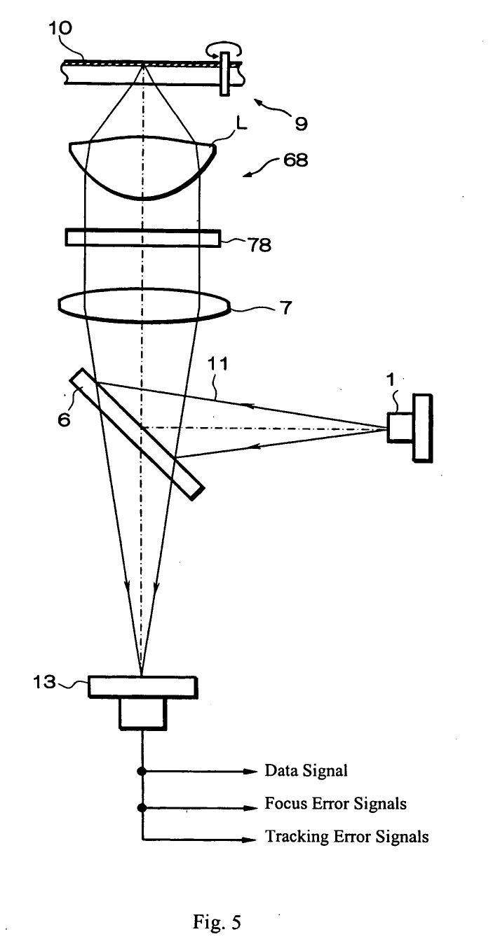

For example, as shown in FIG. 5, an objective optical system 68 includes a holographic optical element 78 having wavelength-multiplexed holograms recorded therein and an objective lens L arranged in this order from the light source side between the collimator lens 7 and the optical recording medium 9. In addition, the same reference symbols are used for the other parts of the optical pickup device of FIG. 5 that have a similar function to the similarly illustrated parts of the optical pickup device of FIG. 1.

In this case, interference patterns are recorded on the holographic optical element 78 so that a specific amount of chromatic aberration is corrected for each wavelength. During the recording/reading operation of the optical recording medium 9, the holographic optical element 78 corrects chromatic aberration that is generated based on the wavelength of the light used.

A method of manufacturing the holographic optical element 78 with wavelength-multiplexed hologram recordings, as described above, will now be described.

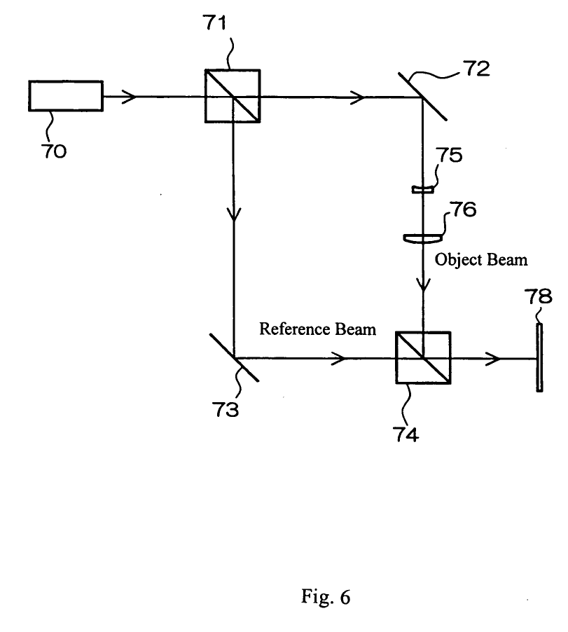

FIG. 6 is a schematic diagram for explaining the formation of holograms in the holographic optical element of the objective optical system for optical recording media of FIG. 5 by wavelength variations of the light used for recording the holograms. Multiple exposures result in wavelength-multiplexed holograms being recorded in the holographic optical element 78 that provide for correction of chromatic aberration.

As shown in FIG. 6, first, a light beam with a specific wavelength is output using a variable-wavelength laser 70 and, after the diameter of the beam is expanded and collimated by an optical system (not shown), the light beam is split by a beamsplitter 71 into an object beam and a reference beam. The object beam enters a beam splitter 74 via a beam expander comprising a mirror 72, a concave lens 75 and a convex lens 76, and the reference beam enters the beamsplitter 74 via the mirror 73. At this time, the relative distances of the concave lens 75 and the convex lens 76 are set to be standard distances so that collimated light exits from the beam expander. In the beamsplitter 74, the object beam and the reference beam are combined to generate interference and the holographic optical element 78, that is set perpendicular to the optical axis of the combined light beam, is illuminated. In this manner a first interference pattern that defines a hologram is recorded within the holographic optical element 78 using known light sensitive materials.

Then, while maintaining the reference beam in the same state, the distance along the optical axis between the concave lens 75 and the convex lens 76 of the beam expander is changed by a specific distance (for example, a few micrometers) in order to change the object beam so that the light exiting from the beam expander is either diverging or converging. At the same time, the output wavelength from the variable-wavelength laser 70 is changed a specific amount, for example, +1 nm, and a second interference pattern using light of this wavelength is formed on the holographic optical element 78. This same process is repeated so that multiple holograms for correcting chromatic aberration are prepared. The range of wavelength variation of the variable wavelength laser 70 is, for example, approximately ±3 nm. In this case, the hologram is formed by wavelength-multiplexed recordings of interference patterns at seven different wavelengths.

Additionally, the objective optical system for the optical recording media and the optical pickup device according to the present invention can be variously modified from the embodiments described above. For example, instead of preparing the holographic optical elements using multiple exposures as described above, the holograms may be computer generated holograms.

In addition, the holographic optical element can be formed so as to simultaneously correct both spherical aberration and chromatic aberration, both coma aberration and chromatic aberration, or to simultaneously correct spherical aberration, coma aberration and chromatic aberration.

Furthermore, although in the embodiments described above, an arrangement in which the hologram and the optical axis are arranged at a right angle is used as a standard arrangement, in order to reduce the noise influence of light reflected from the holographic optical element, a standard arrangement with a specific tilt to the optical axis, for example, five degrees, may be used.

Additionally, the objective optical system for optical recording media of the present invention may include additional optical elements to those described above.

Moreover, in the preparation of the holographic optical element described above, a beam expander is formed as a combination of a concave lens and a convex lens. However, a combination of two convex lenses may be used instead. For example, it is possible to make the diameters of light beams entering and exiting the beam expander to be the same by using two convex lenses having the same focal length. In addition, instead of using a beam expander, an SLM (Spatial Light Modulator) element, such as a liquid crystal element, may be used in making angularly-multiplexed recordings, which are effective for both spherical aberration correction and coma aberration correction, and in making wavelength-multiplexed recordings. Furthermore, when angularly-multiplexed holograms are used to correct spherical aberration, multiplex recordings can be carried out using a convex lens or a concave lens that has a different focal length each time a recording is made.

Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An objective optical system for focusing a light beam from a light source onto an optical recording surface of an optical recording media comprising, arranged along an optical axis:
a holographic optical element that includes angularly-multiplexed holograms for correcting spherical aberration or coma aberration; and
an objective lens.

2. The objective optical system according to claim 1, wherein:
said holographic optical element is tiltable about at least one axis intersecting said optical axis;
said holographic optical element is constructed so that, when said holographic optical element is tilted to a first position, a substantially collimated light beam incident on said holographic optical element along said optical axis will exit from said holographic optical element as a divergent light beam, and when said holographic optical element is tilted to a second position, a substantially collimated light beam incident on said holographic optical element along said optical axis will exit from said holographic optical element as a convergent light beam; and
when the substantially collimated light beam incident on said holographic optical element is focused on an optical recording media having a substrate thickness thicker than a specified thickness, the holographic optical element is tilted to said first position such that spherical aberration is corrected at the focus of the light beam, and
when the substantially collimated light beam incident on said holographic optical element is focused on an optical recording media having a substrate thickness thinner than said specified thickness, the holographic optical element is tilted to said second position such that spherical aberration is corrected at the focus of the light beam.

3. The objective optical system according to claim 1, wherein said holographic optical element is constructed so that, when said holographic optical element is tilted to a first position, a substantially collimated light beam incident on said holographic optical element along said optical axis will exit from said holographic optical element as a light beam so that coma aberration, that otherwise would cause blurring at the focus of the light beam, is corrected.

4. The objective optical system according to claim 1, wherein said holographic optical element is constructed so that:
(a) when said holographic optical element is tilted to a first position about a first axis perpendicular to said optical axis, a substantially collimated light beam incident on said holographic optical element along said optical axis will exit from said holographic optical element so that coma aberration is corrected at the focus of the light beam; and
(b), when said holographic optical element is tilted to a second position about a second axis perpendicular to said optical axis and to said first axis, a substantially collimated light beam incident on said holographic optical element along said optical axis will exit from said holographic optical element so that spherical aberration is corrected at the focus of the light beam.

5. The objective optical system according to claim 1, further comprising:
a light source for emitting a light beam to be focused by the objective optical system;
an actuator for tilting the holographic optical element specified amounts;
a detector for detecting aberration information related to spherical aberration or coma aberration of the light beam; and
a control unit for comparing aberration information detected by said detector with standard values and for sending drive command signals to said actuator, based on the results of the comparison, so that new values of the aberration information are detected by the detector to indicate correction of aberration by the actuator tilting the holographic optical element.

6. The objective optical system according to claim 2, further comprising:
a light source for emitting a light beam to be focused by the objective optical system;
an actuator for tilting the holographic optical element specified amounts;
a detector for detecting aberration information related to spherical aberration or coma aberration of the light beam; and
a control unit for comparing aberration information detected by said detector with standard values and for sending drive command signals to said actuator based on the results of the comparison so that new values of the aberration information are detected by the detector to indicate correction of aberration by the actuator tilting the holographic optical element.

7. The objective optical system according to claim 3, further comprising:
a light source for emitting a light beam to be focused by the objective optical system;
an actuator for tilting the holographic optical element specified amounts;
a detector for detecting aberration information related to spherical aberration or coma aberration of the light beam; and
a control unit for comparing aberration information detected by said detector with standard values and for sending drive command signals to said actuator based on the results of the comparison so that new values of the aberration information are detected by the detector to indicate correction of aberration by the actuator tilting the holographic optical element.

8. The objective optical system according to claim 4, further comprising:
a light source for emitting a light beam to be focused by the objective optical system;
an actuator for tilting the holographic optical element specified amounts;
a detector for detecting aberration information related to spherical aberration or coma aberration of the light beam; and
a control unit for comparing aberration information detected by said detector with standard values and for sending drive command signals to said actuator based on the results of the comparison so that new values of the aberration information are detected by the detector to indicate correction of aberration by the actuator tilting the holographic optical element.

9. An objective optical system for focusing a light beam from a light source onto an optical surface of an optical recording medium comprising, arranged -along an optical axis:
a holographic optical element that includes wavelength-multiplexed holograms for correcting chromatic aberration; and
an objective lens.

10. The objective optical system according to claim 9, wherein said holographic optical element is constructed so that, when a substantially collimated light beam having a wavelength shorter than a specified wavelength is incident on said holographic optical element along said optical axis, a divergent light beam exits from said hologram, and when a substantially collimated light beam having a wavelength longer than said specified wavelength is incident on said holographic optical element along said optical axis, a convergent light beam exits from said hologram.

11. An optical pickup device comprising:
the objective optical system of claim 9; and
a light source for providing the light beam for focusing onto the optical surface of the optical recording medium.

12. An optical pickup device comprising:
the objective optical system of claim 10; and
a light source for providing the light beam for focusing onto the optical surface of the optical recording medium.

13. An optical pickup device comprising:
the objective optical system of claim 1; and
a light source for providing the light beam for focusing onto the optical surface of the optical recording medium.

14. An optical pickup device comprising:
the objective optical system of claim 2; and
a light source for providing the light beam for focusing onto the optical surface of the optical recording medium.

15. An optical pickup device comprising:
the objective optical system of claim 3; and
a light source for providing the light beam for focusing onto the optical surface of the optical recording medium.

16. An optical pickup device comprising:
the objective optical system of claim 4; and
a light source for providing the light beam for focusing onto the optical surface of the optical recording medium.
